(19) United States
(12) Patent Application Publication
(10) Pub. No.: US 2008/0137536 A1
(43) Pub. Date: Jun. 12, 2008

(54) Method for Managing Network Node Overload and System Thereof

(76) Inventor: Patrice Hede, Enghien-les-Bains (FR)

Correspondence Address: BIRCH STEWART KOLASCH & BIRCH, PO BOX 747, FALLS CHURCH, VA, 22040-0747, US

(21) Appl. No.: 11/814,981

(22) PCT Filed: Mar. 28, 2006
(86) PCT No.: PCT/KR06/01130

§ 371 Date: Jul. 27, 2007

Related U.S. Application Data
(60) Provisional application No. 60/666,387, filed on Mar. 29, 2005.

(51) Int. Cl. H04L 1/00

(52) U.S. Cl. 370/236

(57) ABSTRACT

A method for managing a network node overload and a communication network system thereof, wherein upon transferring to a network entity (i.e., the RNC or CN entity) at least one or more information elements by being included in a certain message through an Iu interface (or an IuFlex interface) which connects an RNC with a CN entity, the network entity having received the certain message performs a particular algorithm (i.e., an algorithm corresponding to the certain message) to control a signaling load between the RNC and the CN entity, thereby preventing in advance and managing an overload of a certain network node.

### TECHNICAL FIELD

The present invention relates to an overload of network nodes, and more particularly, to a method for managing an overload of a network node and a communication network system thereof.

### BACKGROUND ART

A 3^{rd} Generation Partnership Project (3GPP) network can comprise a Radio Access Network (RAN) entity such as a Radio Network Control (RNC), and a Core Network (CN) entity such as a Serving GPRS Support Node (SGSN) or a Mobile Switching Center (MSC). The RNC is connected to the CN via an Iu interface to thus exchange signaling each other.

However, an overload may problematically occur in a certain network entity (e.g., the CN entity or the RNC) under a specific communication environment of the 3GPP network. The 3GPP specification (i.e., 3GPP TS 25.413) discloses the overload of the certain network entity. However, the overload disclosed in the current 3GPP specification is related to only the overload of the CN entity, which is referred to as “overload control”.

Hereafter, the overload control disclosed in the current 3GPP specification will now be explained.

Namely, the overload control related to a signaling flow control forcibly reduces signaling loads. In more detail, a current 3GPP specification (i.e., 3GPP TS 25.413 §8.25) discloses a procedure that a Radio Access Network Application Port (RANAP) protocol controls an overload on an Iu interface. Here, the SGSN notifies (sends or indicates) the RNC of its overload state using a particular message. Here, in order to indicate the overload of a particular CN entity, only the CPU overload has been considered so far. Accordingly, there has been provided only a method for decreasing a signaling toward a particular node (i.e., the CN entity) already in the overload state or an entire CN domain (which includes a Packet Switched (PS) domain or a Circuit Switched (CS) domain, and indicates a CN domain already in the overload state).

### DISCLOSURE OF INVENTION

### Technical Problem

However, the related art signaling overload control remain at a technical limitation that the controlling operation is performed only when the CN entity is already in the overload state. In other words, after the particular entity (e.g., the CN entity or the RNC) gets into the overload state, an operation corresponding thereto is then executed which causes the technical limitation of the overload control disclosed in the current 3GPP specification. Namely, not proposed is any method for preventing the overload state of the particular entity is prevented before its occurrence.

Furthermore, in the related art signaling control, a signaling which is sent from the CN entity toward the RNC is just considered, but any method for controlling a load of signaling sent from the RNC to the CN entity is not provided.

Particularly, because a drastic increase in signaling degrades quality of a certain service and a network performance as in a Multimedia Broadcast/Multicast Service (MBMS) counting procedure, a certain user equipment which desires to participate in a particular service (e.g., the MBMS) becomes more difficult to be successfully connected to the particular service and also user equipment having previously participated in the particular service may be dropped from the service or may not achieve good service quality. Hence, a technique for preventing beforehand and managing the overload of the network nodes is required so as to maintain the network service qualities and constant network performances even if the signaling is drastically increased in the network entities.

### Technical Solution

Therefore, it is an object of the present invention to provide a method for managing a network overload (or network node overload) which is capable of increasing possibility that a particular procedure is successfully performed by decreasing probability that an overload occurs in a network entity, and a system thereof.

To achieve these objects, there is provided a method for managing a network node overload comprising sending, by a first entity, at least one or more information elements related thereto before reaching an overload state, and using the information elements, by a second entity, to control a signaling load between the first entity and the second entity.

Preferably, the signaling load control may comprise analyzing the at least one or more information elements related to the first entity by the second entity, and performing a certain algorithm which is pre-set between the first and second entities based upon the analysis for the information elements.

Preferably, the method for managing the network node overload can further comprise determining whether the first entity is in a state to transfer the at least one or more information elements to the second entity.

To achieve these objects, there is provided a communication network system in a communication network system including at least one or more entities comprising a first entity to transfer at least one or more information elements for controlling a signaling load before an occurrence of an overload to at least one or more second entities, and the at least one or more second entity to control the signaling load with the first entity using the at least one or more information elements sent from the first entity.

### BRIEF DESCRIPTION OF THE DRAWINGS

FIG. 1 is an embodiment of the present invention which shows a signal flow of a method for managing an overload of a signaling sent from a CN to an RNC in a communication network system according to the present invention; and

FIG. 2 is another embodiment of the present invention which shows a signal flow of a method for managing an overload of a signaling sent from an RNC to a CN in a communication network system according to the present invention.

### MODE FOR THE INVENTION

Reference will now be made in detail to the preferred embodiments of the present invention, examples of which are illustrated in the accompanying drawings. It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

Hereinafter, constructions and operations shown in embodiments of the present invention will be explained with reference to the attached drawings. In the present invention, a CN can include a CS domain and a PS domain, and the CN can also include at least one or more CN entities. The CN entity is operated as a certain node of the CN. The CN entity is connected to at least one or more RNCs belonging to a UTRAN via an Iu interface. For example, the CN entities include an MSC corresponding to the CS domain and an SGSN corresponding to the PS domain.

The present invention will be explained based upon an embodiment which is applied to an overload due to an MBMS procedure and to an Iuflex overload. Here, applying the embodiment to the present invention is to achieve well understanding of the present invention and a brief explanation therefor. However, the embodiment may not limit or restrict embodiments which can be implemented in the present invention.

First, an explanation will be given for a case of an MBMS overload occurrence. Based upon a 3GPP MBMS related specification (i.e., 3GPP TS 23.246, §8.1 MBMS notification), the RNC can determine the number of user equipment (UEs) (or terminals) to be moved into a PMM-CONNECTED mode during an MBMS counting procedure. The RNC, on the other hand, sends PS signaling establishment request signals requested by at least one or more UEs to the CN entity (e.g., the SGSN). The PS signaling establishment request signal continuously sent from the RNC to the SGSN may cause an overload of the SGSN. That is, the RNC does not have information related to a current load of the CN entity (e.g., the SGSN), and accordingly the RNC can not appropriately control (or adjust) a highest load of the signaling toward the SGSN, which may be caused in the following cases that: the RNC generates a Packet Mobility Management (PMM) connection in a short time to thus restrict delay for a session setup when initiating an MBMS session; the RNC does not have information related to capacity of the SGSN required for maintaining a signaling load due to its MBMS signaling; and the RNC does not have information related to loads occurred in the SGSN due to other RNCs (Here, the loads include a load caused by the MBMS connection and loads caused by connections other than the MBMS connection). Because of the reasons, the RNC can not calculate the highest load toward the SGSN and can not calculate an approximate value of the highest load.

Next, an explanation will be given for a case of the Iuflex overload occurrence. In an Iuflex related specification based upon the 3GPP, for a network constructed to use the Iuflex, one RNC can be connected to a plurality of CN entities (e.g., a plurality of SGSNs). When a certain UE (or terminal) sends an incoming connection signal to the RNC, the RNC must select a certain CN node (i.e., the CN entity) for the UE. However, a current algorithm to select the certain CN node does not consider a current load of each CN node corresponding to candidates (i.e., at least one or more CN nodes) to be selected by the RNC. Accordingly, the RNC can select a certain CN node relatively closer to the overload state as compared to other candidate CN nodes, which is resulted from that a certain network entity can not recognize the states related to loads of other entities.

Hence, primarily, the present invention uses control information for controlling current loads of the RNC and CN entities (e.g., one of the SGSN and MSC or both of them) to previously prevent an overload between the RNC and the CN entity, and to manage the network. The basic concept of the present invention can be implemented by adding a new signaling to the Iu interface which connects the RNC with the CN entity. That is, the CN entity notifies (or indicates) the RNC of its current load using the new signaling. Accordingly, the RNC can adjust a signaling behavior toward the CN entity. In addition, such concept of the present invention can be directly applied to the management of the overload of the signaling from the RNC to the CN entity, and thus the CN entity can adjust the signaling toward the RNC.

Hereinafter, explanations will be respectively given for an embodiment in which the signaling is sent from the CN to the RNC and an embodiment in which the signaling is sent from the RNC to the CN. However, the embodiments expressed in the present invention may not limit or restrict the scope of the present invention and may just be proposed to keep briefly explaining the present invention.

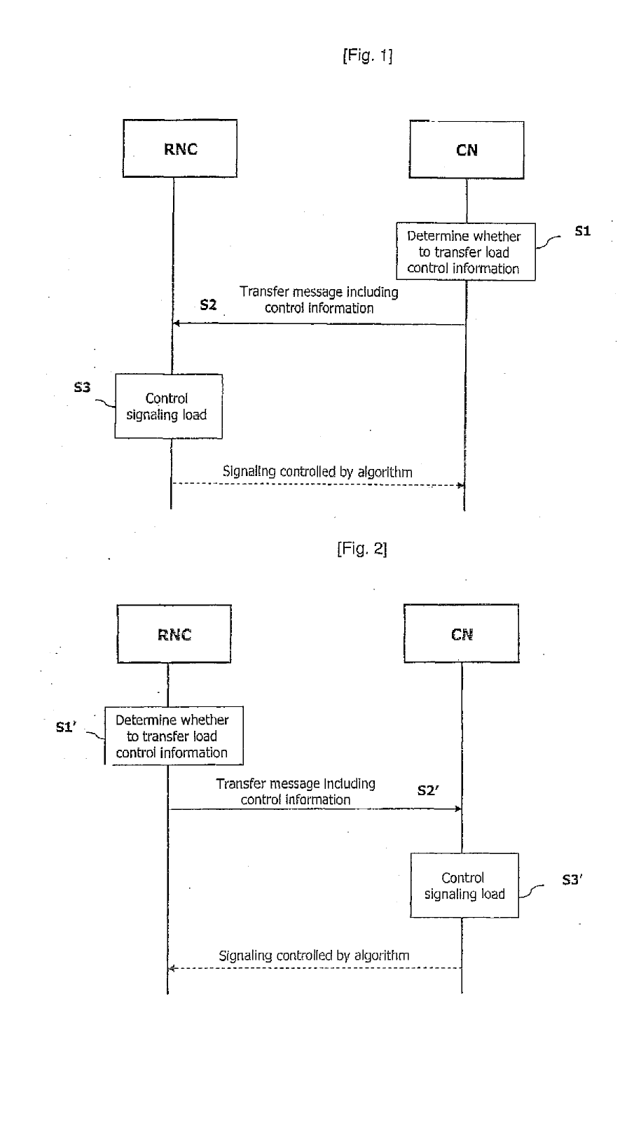

FIG. 1 is an embodiment of the present invention which shows a signal flow of a method for managing an overload of a signaling sent from a CN to an RNC in a communication network system according to the present invention.

Briefly explaining the embodiment of FIG. 1, the CN entity determines whether to send control information for controlling its load to the RNC according to the change in a signaling load (S1), and includes the control information related to its load in a certain message to thus deliver the message to the RNC connected thereto via the Iu interface (S2).

The RNC analyzes the control information related to the load of the CN entity. The RNC then uses a particular algorithm which is pre-set between the RNC and the CN entity based upon the analyzed result to thus control the signaling load from the RNC to the CN entity (S3). Accordingly, the signaling overload of the CN entity can be prevented beforehand by the steps S1 through S3.

The one embodiment according to the present invention will now be explained in more detail with reference to FIG. 1 hereafter.

That is, when a considerable change occurs in the signaling load in the CN entity as in an MBMS session initiation, the CN entity determines whether to deliver to the RNC control information (i.e., control information for controlling a load) related to the change of load thereof (S1). Here, the CN entity sends to the RNC the control information related to the change of the load in cases as follows. Namely, when the load occurred in the CN entity is considerably increased more than a pre-set level or decreased less than the pre-set level, as compared to the pre-set level (e.g., the pre-set level may be a signaling load amount in a normal state that the CN entity processes the signaling), the CN entity sends the control information about the change of load to the RNC (In this case, the increase or the decrease in the change of load is determined by a certain policy or a configuration of a system operator). When the function of the CN entity is degraded due to various causes affecting the function thereof (e.g., a cause related to software failure, a cause related to hardware, a cause related to maintenance, or the like), the CN entity sends to the RNC the control information about the change of its load. When a particular procedure which requires considerable signaling resources should be executed as in the MBMS session initiation, the CN entity sends to the RNC the control information about the change of its load. When the CN entity periodically sends the control information about its load to the RNC, the CN entity sends to the RNC the control information related to the change of its load. In addition, when the CN entity sends to the RNC the control information about its load after a pre-set time duration elapses after sending a certain message, the CN entity sends to the RNC the control information related to the change of load.

In the step S1, upon determining to deliver to the RNC the control information about its load, the CN entity sends to the RNC the control information about its load. Here, the control information of the CN entity sent from the CN entity to the RNC is sent as a format of a certain parameter.

The certain parameter may be a parameter referred to as a type of information element. Also, the certain parameter can be included into a particular message which is used as a signaling on the Iu interface (i.e., an interface between the RNC and the CN entities). Here, the particular message may be a message having currently used (e.g., ACK, etc.) or a message newly defined on the Iu interface. The newly defined message, namely, indicates a message newly defined to transfer the information element of the CN entity (including control information related to the load of the CN entity) to the RNC. On the other hand, the particular message (i.e., the existing message or the newly defined message) sent from the CN entity can include at least one or more information elements.

Types of the information elements sent from the CN entity to the RNC, on the other hand, can respectively include an information element for requesting a reduction of a current signaling by a certain amount, an information element for requesting a restriction of calls belonging to certain categories, an information element which is sent based upon a time duration (or periodically) (e.g., an information element for requesting a stopping of a signaling for a certain time duration), and an information element for informing a current capacity of a particular network node.

Hereinafter, properties of the information elements will be explained in more detail.

First, the information element related to the reduction of the current signaling by the certain amount may compare a current signaling state with a normal operation state (i.e., a signaling in a normal state) to thus drop the signaling by a certain percentage of incoming requests (e.g., “reducing signaling by 15%”) or to delay the connections of the incoming requests. In addition, the information element slows down a connection establishment speed of the incoming requests to thus reach a pre-set low speed signaling rate.

Second, regarding the information for requesting the restriction of the calls belonging to the certain categories, the calls in the certain categories to be restricted may include, for example, packet-switched calls, circuit-switched calls, MBMS requests, calls according to an establishment cause provided by the UE, calls according to access service classes, or the like.

Third, the information element for requesting the stopping or restricting of the signaling until receiving subsequent instructions from an entity (i.e., the CN entity) may request a signaling stopping for a certain duration, and also can request the signaling stopping partially or completely. Here, the certain duration can be determined by a current load of a certain network node (e.g., the CN entity) or by an operator configuration. The information element may be indicated, for example, as “stop signaling for two minutes” or “stop signaling until further instructed”.

Fourth, the information indicating the current remaining capacity of the network node (e.g., the CN entity) may indicate percentage (e.g., “the current node at 65% capacity”) of remaining resources such as a CPU, a bandwidth, or an interface.

Upon receiving a certain message containing at least one or more of the information elements from the CN entity, the RNC may analyze the received information elements and may control a signaling load with the CN entity accordingly (S3). That is, the RNC may perform an algorithm which is pre-set between the RNC and the CN entity to thus control the signaling load toward the CN entity. For example, if the certain message received from the CN entity to the RNC contains the fourth information element (e.g., the CN entity at 65% capacity currently), the algorithm pre-defined between the RNC and the CN entity may be applied to perform a signaling load control corresponding to the first through third information elements. For an MBMS session initiation, for example, the RNC may reduce the number of PMM establishments before the MBMS initiation according to the load of the CN entity (e.g., the SGSN) so as to increase delay due to an MBMS related counting, resulting in the reduction of the signaling load sent from the RNC toward the CN entity (i.e., the SGSN).

If the RNC is connected to a plurality of other CN entities in addition to the CN entity (e.g., a first SGSN) (i.e., other CN entities are referred to as least one or more other SGSNs except the first SGSN) via the Iuflex interface, the RNC can select another CN entity based upon the current signaling load of the CN entity (i.e., the first SGSN). Hence, it is possible to optimize a balance of the signaling load between the RNC and the CN entity.

Thus, through the processes (S1 through S3), the method has been disclosed such that the RNC receives the current state (i.e., the control information related to the load) of the CN entity from the CN entity, and then the certain algorithm can be used to previously design appropriate signaling rate and signaling timing toward the CN node (i.e., the CN entity). Here, the certain algorithm for performing the signaling control between the RNC and the CN entity indicates an algorithm for analyzing each of the information elements (i.e., the first through fourth information elements) to thus perform the signaling control corresponding to each of them.

FIG. 2 is another embodiment of the present invention which shows a signal flow of a method for managing an overload of a signaling sent from an RNC to a CN in a communication network system according to the present invention.

The concept of the present invention above described as in FIG. 2 may equally be applied to the embodiment of FIG. 2. Referring to FIG. 2, the information elements (i.e., the first through fourth information elements) can be included in a certain message sent from the RNC to the CN entity. The certain message sent from the RNC may be a message having currently used on the Iu interface connecting it to the CN entity or a newly defined message.

Also, the procedures illustrated in FIG. 1 can equally be applied to the embodiment of FIG. 2. Accordingly, the step S1 in the embodiment of FIG. 1 corresponds to a step S1′ in the embodiment of FIG. 2, the step S2 to a step S2′ and the step S3 to a step S3′. However, the operating entity illustrated in the embodiment of FIG. 1 is opposite to one in the embodiment of FIG. 2. That is, the CN entity of FIG. 2 substitutes for the RNC of FIG. 1, and the RNC of FIG. 2 substitutes for the CN entity of FIG. 1.

Briefly explaining the embodiment of FIG. 2, the RNC may determine whether to send control information related to its load based upon the change in a signaling load (S1′) to thus send the control information related to its load by being included in a certain message to the CN entity connected thereto via the Iu interface (S2′). The CN entity then may analyze the control information related to the RNC load and may accordingly control the signaling load sent from the CN entity toward the RNC using a certain algorithm which is pre-set between the RNC and the CN entity (S3′). Through the processes (S1′ through S3′), the CN entity can control (adjust) the signaling load with respect to an incoming traffic sent from the CN entity to the RNC, thereby previously preventing a signaling overload of the RNC.

In addition, the sending of the control information in the step S1 is the same as the step S1 of FIG. 1. When at least one or more RNCs are connected to the CN entity via the Iuflex interface, as similar to the RNC's selecting of another CN entity which is relatively less loaded, the CN entity, in FIG. 2, selects another RNC which is relatively less loaded to thus send the incoming traffic to the selected RNC. A detailed explanation of the embodiment of FIG. 2 is the same as that of the embodiment of FIG. 1 to thus be omitted.

As aforementioned, the present invention can effectively prevent in advance and manage the overload of the certain network node (i.e., the RNC or CN entity) by controlling or adjusting the signaling between the RNC and the network entity (i.e., the CN entity) which are connected via the Iu interface (or the Iuflex interface).

Accordingly, in view of the network, according to the present invention, by previously recognizing the load of the signaling generated in a certain network node (e.g., RNC, or SGSN or MSC as CN entity), it is possible to maintain quality of a certain service such as the MBMS service provided from the network and it is effective to efficiently manage the network performance.

In addition, in view of the UE (or terminal) connected to the RNC in the UTRAN, the UEs joining in a particular service such as the MBMS can effectively be provided with the service without being disconnected from the service. Besides, probability that the UEs which attempt to join in the particular service such as the MBMS can be successfully joined in the particular service in order to set a session therewith can be improved, and delay time for the session setup (establishment) can be reduced.

1. A method for managing a network node overload comprising:
sending, by the first entity, at least one or more information elements related thereto to a second entity before reaching an overload state; and
using the information elements, by the second entity, to control a signaling load between the first entity and the second entity.

2. The method of claim 1, wherein the information element is to control the load of the first entity.

3. The method of claim 1, wherein the information element is sent by being included in a certain message.

4. The method of claim 3, wherein the certain message is a message used over an interface between the first and second entities.

5. The method of claim 3, wherein the certain message is a newly defined message to be used over the interface between the first and second entities.

6. The method of claim 3, wherein the certain message includes at least one or more of the information elements related to the first entity.

7. The method of claim 1, wherein the first entity denotes a Radio Access network (RAN) and the second entity denotes a Core Network (CN) entity.

8. The method of claim 7, wherein when the first entity is the RAN and the second entity is the CN entity, a signaling sent from the CN entity to the RAN is controlled.

9. The method of claim 1, wherein when the first entity denotes the CN entity and the second entity denotes the RAN.

10. The method of claim 9, wherein when the first entity is the CN entity and the second entity is the RAN, a signaling sent from the RAN to the CN entity is controlled.

11. The method of claim 7 or 9, wherein the RAN includes at least a Radio Network Control (RNC).

12. The method of claim 7 or 9, wherein the CN entity is at least one of a Serving GPRS Support Node (SGSN) and a Mobile Switching Center (MSC).

13. The method of claim 1, wherein the information element includes information for requesting a reduction of a current signaling between the first and second entities by a certain amount.

14. The method of claim 1, wherein the information element includes information for requesting a slow-down of a current signaling rate between the first and second entities by a pre-set signaling rate.

15. The method of claim 1, wherein the information element includes information for restricting at least one or more calls belonging to certain categories.

16. The method of claim 1, wherein the information element includes information for requesting restricting or stopping of a signaling for a certain time duration.

17. The method of claim 1, wherein the information element includes information for informing a current capacity of the first entity.

18. The method of claim 1, wherein the controlling of the signaling load includes:
Analyzing, by the second entity, at least one or more information elements related to the first entity; and
performing a certain algorithm which is pre-set between the first and second entities based upon the analysis for the at least one or more information elements.

19. The method of claim 18, wherein the algorithm controls the signaling sent from the second entity to the first entity based upon the at least one or more information elements related to the first entity which has been received by the second entity.

20. The method of claim 18, wherein the algorithm is used to optimize a balance of traffic between the first and second entity when using an Iuflex interface between the first and second entities.

21. The method of claim 20, wherein the algorithm is used to optimize the balance of the traffic between the first and second entities by allowing the second entity to select another network node to process a certain traffic using an information element related to control information of the first entity.

22. The method of claim 1, wherein the signaling control includes a signaling control with respect to a Packet-Switched (PS) domain or a Circuit-Switched (CS) domain.

23. The method of claim 1, further comprising:
determining, by the first entity, whether the first entity is in a state to send the at least one or more information elements to the second entity.

24. The method of claim 23, wherein the state to send the information elements includes at least one or more of:
a state in which the load of the first entity is increased more than a pre-set level or decreased less than the pre-set level;
a state in which a particular period or duration to deliver the information elements is pre-set; and
a state in which a performance of the first entity is degraded less than a pre-set level.

25. A communication network system in a communication network system including at least one or more entities comprising:
a first entity for transferring at least one or more information elements for controlling a signaling load to at least one or more second entities before reaching an overload state; and
the at least one or more second entities for controlling a signaling load with the first entity by using the at least one or more information elements sent from the first entity.

26. The system of claim 25, wherein the first entity denotes an RAN and the second entity denotes a CN entity.

27. The system of claim 26, wherein when the first entity is the RAN and the second entity is the CN entity, a signaling sent from the CN entity to the RAN is controlled.

28. The system of claim 25, wherein the first entity denotes the CN entity and the s second entity denotes the RAN.

29. The system of claim 28, wherein when the first entity is the CN entity and the second entity is the RAN, a signaling sent from the RAN to the CN entity is controlled.

30. The system of claim 26 or 28, wherein the RAN includes at least an RNC.

31. The system of claim 26 or 28, wherein the CN entity is at least one of an SGSN and an MSC.

32. The system of claim 25, wherein the information element is sent by being included in a particular message.

33. The system of claim 32, wherein the particular message is a message used over an interface between the first entity and the second entity.

34. The system of claim 32, wherein the particular message is a newly defined message to be used over the interface between the first entity and the second entity.

35. The system of claim 25, wherein the first entity sends to the second entity an information element for requesting a reduction of a current signaling between the first and second entities by a certain amount.

36. The system of claim 25, wherein the first entity sends to the second entity an information element for requesting a slow-down of a current signaling rate between the first and second entities to thus allow the current signaling rate to reach a certain pre-set signaling rate.

37. The system of claim 25, wherein the first entity sends to the second entity an information element for requesting a restriction of at least one or more calls belonging to certain categories.

38. The system of claim 25, wherein the first entity sends to the second entity an information element for requesting restricting or stopping of the signaling toward the first entity for a certain time duration.

39. The system of claim 25, wherein the first entity sends to the second entity an information element related to a current load capacity thereof.

40. The system of claim 25, wherein the second entity analyzes the at least one or more information elements having received from the first entity.

41. The system of claim 40, wherein the second entity selects a certain network node to process a particular traffic sent from the second entity to the first entity and sends the particular traffic to the selected network node.

42. The system of claim 41, wherein the network node denotes another RAN when the second entity is the CN entity and the first entity is the RAN.

43. The system of claim 41, wherein the network node denotes another CN entity when the second entity is the RAN and the first entity is the CN entity.
